(19) United States
(12) Patent Application Publication
(10) Pub. No.: US 2023/0394014 A1
(43) Pub. Date: Dec. 7, 2023

(54) METHOD AND SYSTEM FOR RETRIEVING DATA ON A WEB PAGE BY PERFORMING A SIMULATED USER OPERATION ON A TARGET WEB PAGE

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(73) Assignee: DUN-QIAN Intelligent Technology Co., Ltd., Taichung City (TW)

(21) Appl. No.: 17/881,645

(22) Filed: Aug. 5, 2022

(30) Foreign Application Priority Data
Jun. 7, 2022 (TW) 111120950

(51) Int. Cl. G06F 16/215; G06F 16/958; G06F 8/30

(52) U.S. Cl. CPC G06F 16/215; G06F 16/958; G06F 8/311; G06Q 50/12

(57) ABSTRACT

A method for retrieving data on a web page includes performing a simulated user operation on a target web page to generate a result web page, retrieving a source code of the result web page, creating a data table according to the source code, and performing a data cleaning operation with the data table to generate cleaned data and store the cleaned data in a database. Each temporary row of the data table is corresponding to a quotation plan.

### BACKGROUND OF THE INVENTION

### 1. Field of the Invention

The disclosure is related to a method and a system for retrieving data on a web page, and more particularly, a method and a system for retrieving data by performing a simulated user operation on a target web page.

### 2. Description of the Prior Art

With the development of the tourism industry, users can now inquire about hotel information and quotation plans on the internet, so as to book accommodation. However, the quotation plans and available room types offered by hotels often change over time. For example, if a user books a day's accommodation a month ago, the price will often be cheaper than booking that day's accommodation the day before. In another example, hotels often offer accommodation and dining packages (for example, one night stay with dinner and breakfast), and these offers may not be the norm, but are offered irregularly with marketing plans. For a lot of travel-related information on the internet, there is currently a lack of proper solution to assist users in retrieving relevant information in a real time and convenient manner.

### SUMMARY OF THE INVENTION

An embodiment provides a method for retrieving data on a web page. The method can include performing a simulated user operation on a target web page to generate a result web page, retrieving a source code of the result web page, creating a data table according to the source code, and performing a data cleaning operation with the data table to generate cleaned data and store the cleaned data in a database. Each temporary row of the data table is corresponding to a quotation plan.

Another embodiment provides a system for retrieving data on a web page. The system can include an internet interface, a processor and a database. The internet interface is linked to a target web page at a remote terminal, and is used to perform a simulated user operation on the target web page to generate a result web page, and retrieve a source code of the result web page. The processor is linked to the internet interface, and is used to create a data table according to the source code, and perform a data cleaning operation with the data table to generate cleaned data. The database is linked to the processor, and is used to store the cleaned data. Each temporary row of the data table is corresponding to a quotation plan.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system for retrieving data on a web page according to an embodiment.

FIG. 2 illustrates a flowchart of a method for the system in FIG. 1.

FIG. 3 illustrates the data table in FIG. 1.

FIG. 4 is a flowchart of machine learning according to the result of performing the simulated user operation in FIG. 2.

FIG. 5 is a flowchart of obtaining the hotel information using the system and steps in FIG. 1 to FIG. 4.

### DETAILED DESCRIPTION

In order to effectively deal with the above-mentioned difficulties, embodiments of the disclosure can provide solutions as follows. Herein, when it is mentioned that an object A and an object B are linked to one another, it means that the object A and the object B are linked to one another through a wired path and/or a wireless path, so that data transmission can be performed. Herein, when a plurality of items are linked with “and/or”, it refers to one, a plurality or all of the plurality of items.

According to an embodiment, a simulated user operation can be performed on a target web page (e.g. a web page of an online travel agency) to collect data related to hotels. The collected data can be processed with a data cleaning operation to convert the collected data into a suitable format. The hotel information in the database can be updated according to the cleaned data, and users can read the updated information to book hotels accordingly. The operation of collecting data related to hotel information can be performed periodically (e.g. daily) to update the information. In order to avoid the anti-crawler program set on the target web page from blocking the collection of information, a neural network module can be used to perform machine learning, so that the simulated user operation is closer to the real human behavior, thereby improving the probability of success of using the simulated user operation to retrieve data from the target web page. The related method and system can be as follows.

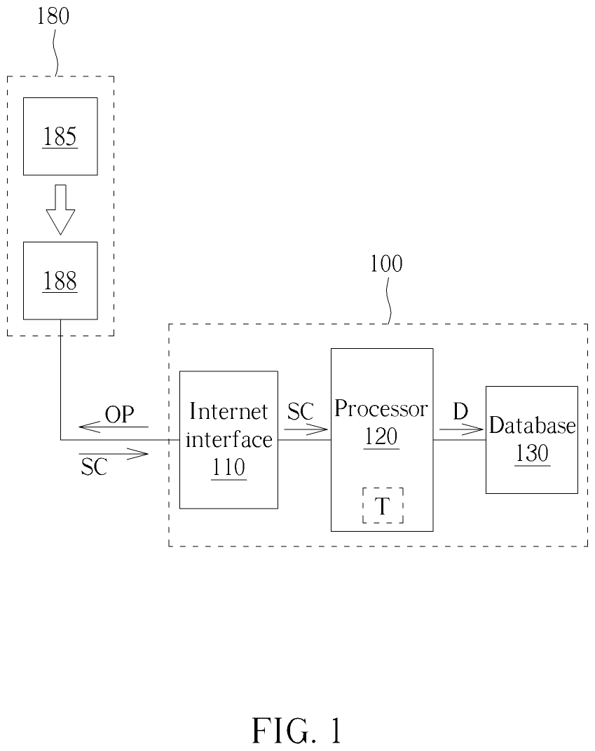

FIG. 1 illustrates a system 100 for retrieving data on a web page according to an embodiment. As shown in FIG. 1, the system 100 can include an internet interface 110, a processor 120 and a database 130. The internet interface 110 can be linked to a target web page 180 at a remote terminal 180 for performing a simulated user operation OP on the target web page 185 to generate a result web page 188, and retrieving a source code SC of the result web page 188. The processor 120 can be linked to the internet interface 110 for creating a data table according to the source code SC, and performing a data cleaning operation with the data table T to generate cleaned data D. The database 130 can be linked to the processor 120 for storing the cleaned data D.

The internet interface can include an interface with integrated hardware and software including an input/output (I/O) interface, a hardware device of network, corresponding programs, a browser and so on. The processor 120 can include at least one of a central processing unit, a microprocessor, an embedded processor and a digital signal processor. The database 130 can include at least one of a local database and a remote database, including related hardware such as a memory array.

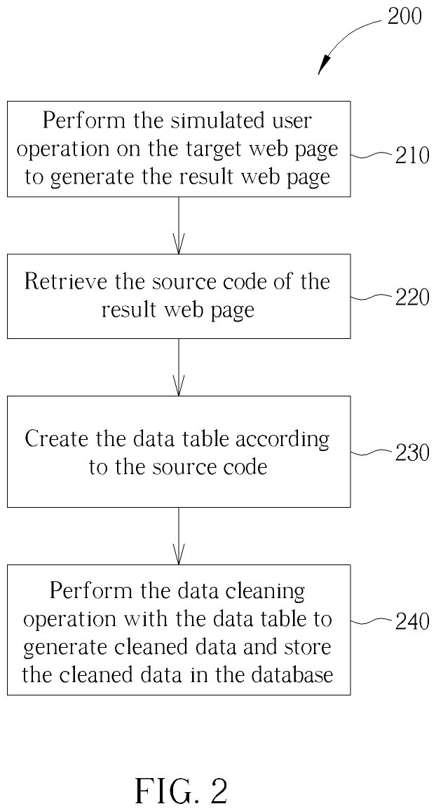

FIG. 2 illustrates a flowchart of a method 200 for the system 100 in FIG. 1. As shown in FIG. 1 and FIG. 2, the method 200 can include the following steps.

Step 210: perform the simulated user operation OP on the target web page 185 to generate the result web page 188;

Step 220: retrieve the source code SC of the result web page 188;

Step 230: create the data table T according to the source code SC; and

Step 240: perform the data cleaning operation with the data table T to generate cleaned data D and store the cleaned data D in the database 130.

For example, the target web page 180 can be a web page of an online travel agency (OTA). In Step 210, the simulated user operation OP simulating human behavior(s) can be performed on the target web page 185 to generate the result web page 188 with search results. The simulated user operation OP can include inputting at least one of a region name (e.g. city name), a hotel name, a reservation date (e.g. check-in date and check-out date, etc.) and the number of people. The simulated user operation OP can be performed on a predetermined operation date, and the result web page 188 and the cleaned data D can be corresponding to the operation date. For example, the simulated user operation OP can be performed periodically (e.g. daily, weekly or every three days) to periodically update the cleaned data D in the database 130.

After performing the simulated user operation, the generated result web page 188 can include a hotel list. For example, after inputting a city name, a hotel list corresponding to the time can be generated. Hence, the result web page 188 can be used to update the hotel list in the database 130. Then, the source code SC can be retrieved according to the updated hotel list.

In FIG. 1 and FIG. 2, the source code SC can include a HyperText Markup Language (HTML) source code. By retrieving and analyzing the complete source code SC instead of directly reading the target web page 185, the failure of data retrieval caused by web page revision and structure change on the target web page 185 is avoided. In addition, by retrieving the source code SC, when the structure of the target web page 185 is changed, there is buffer time to adjust the program, so as to avoid that the data cannot be retrieved when the program is adjusted.

The simulate user operation OP is used for simulating real human behaviors. The simulated user operation OP can include (I) dwelling on the target web page 185 for x units of time, (II) scrolling the target web page 185 upward by m units of length, and/or (III) scrolling the target web page 185 downward by n units of length, so as to simulate real human behaviors. The parameters x, m and n are integers, x≥0, m≥0, n≥0 and x, m and n can be randomly determined. By simulating the behaviors of a real human, the failure of data retrieval caused by being blocked by the anti-crawler program of the remote terminal 180 is prevented.

Regarding the dwell time set in the simulated user operation OP, the dwell time can be randomly generated to be within a predetermined interval (e.g. between 10 and 60 seconds). The operation can dwell on the target web page 185 for the dwell time, and then click to a next web page. The predetermined interval corresponding to the dwell time can be set to an interval to have a classification model successfully predict the data retrieval. Each dwell time before clicking to a next web page can be different from others and can be randomly generated.

The scrolling operation of the simulated user operation can scroll the target web page 185 downward by 1000 units of length, and then scroll upward by 400 units of length. After retrieving the complete source code of the target web page 185 with the scrolling operations, the operation can go to a next web page. In this way, the real human behaviors are simulated.

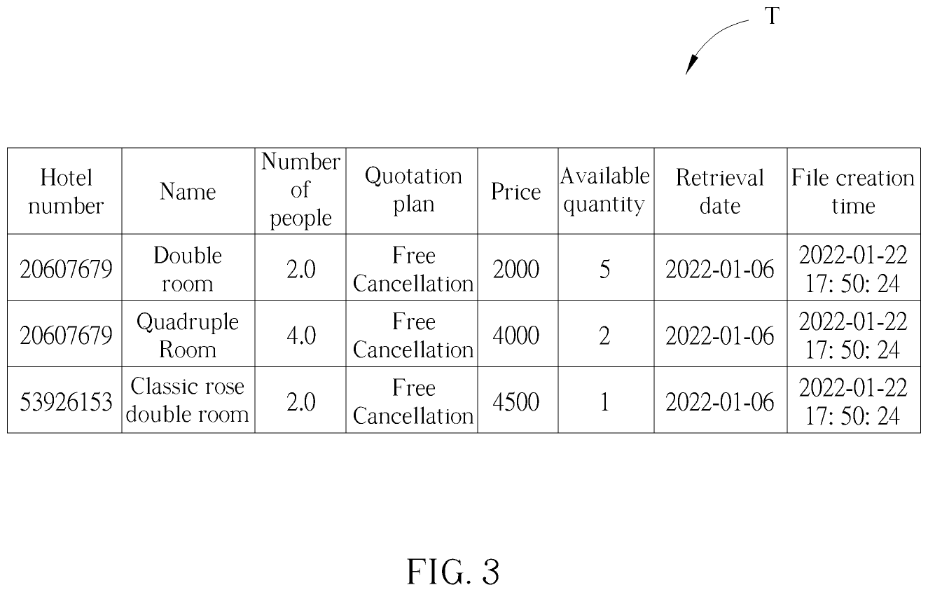

FIG. 3 illustrates the data table T in FIG. 1. As shown in FIG. 3, the data table T can include fields such as hotel number (hotel tag id), name (name), number of people (people), quotation plan (plan), price (price), available quantity (available), retrieval date (crawler date), file creation time (created at). In FIG. 3, each temporary row of the data table T can be corresponding to a quotation plan of a hotel. Taking the first temporary row shown in FIG. 3 as an example, the hotel with the hotel number (hotel tag id) 20607679 currently has 5 available double rooms, each room costs 2000 dollars, and each room can be canceled for free, that is, there is no charge when canceling the reservation. The data in the first temporary row was retrieved on 2022-01-06 (i.e. Jan. 6, 2022), and the data table T was created on 2022-01-22 17:50:42 (i.e. 17:50:42 on Jan. 22, 2022). FIG. 3 is an example instead of limiting the scope of embodiments, and the fields and content of the data table can be adjusted according to actual needs. For example, catering-related fields can also be added to present a quotation plan for accommodation with meals.

After the data table T is generated, the data cleaning operation in Step 240 of FIG. 2 can be performed to clean the content of the data table T into a suitable format for subsequent processing. For example, regarding the characteristics of the room type, two rooms can be first identified whether they are of the same room type by crawling the specific code of the room type given by each website. If the specific code cannot be obtained from the website for identification, the room type can be determined according to the similarity of the room names. For example, “classic rose double room” and “double room” can be identified as having the same characteristics during the data cleaning operation to be both identified as double rooms.

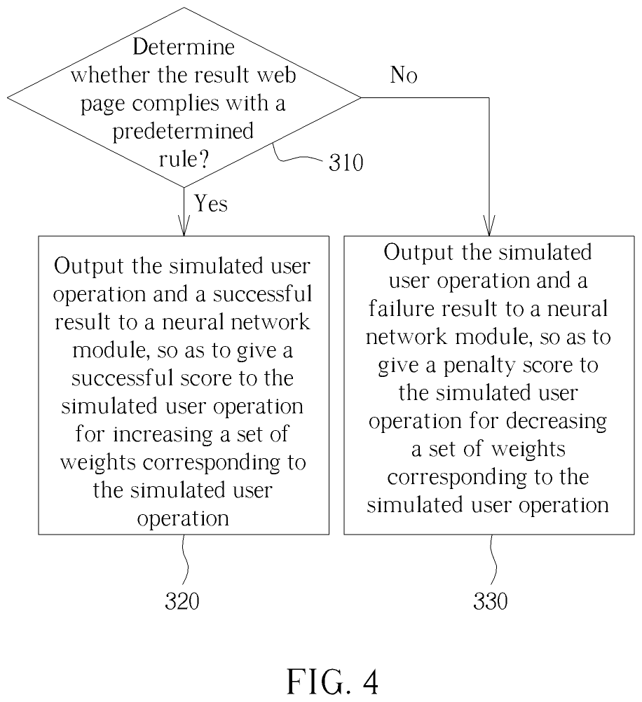

In order to make the simulated user operation OP closer to real human behaviors, machine learning can be used to optimize the simulated user operation OP. FIG. 4 is a flowchart of machine learning according to the result of Step 210 in FIG. 2. As shown in FIG. 4, the following steps can be performed.

Step 310: determine whether the result web page 188 complies with a predetermined rule; if so, enter Step 320; otherwise, enter Step 330;

Step 320: output the simulated user operation OP and a successful result to a neural network module, so as to give a successful score to the simulated user operation OP for increasing a set of weights corresponding to the simulated user operation OP.

Step 330: output the simulated user operation OP and a failure result to a neural network module, so as to give a penalty score to the simulated user operation OP for decreasing a set of weights corresponding to the simulated user operation OP.

In FIG. 4, a trained classification model can be applied to evaluate a probability of success of performing a to-be-evaluated simulated user operation on the target web page 155. If the probability of success is lower than a threshold, the to-be-evaluated simulated user operation can be discarded.

The probability of success can be the probability of using the to-be-evaluated simulated user operation to successfully retrieve related parameters of at least one of an internet-protocol (IP) address, a web-cache, a browser add-on number, a user agent and a hotel sequence.

When the simulated user operation OP is used to simulate real human behaviors, the features of hardware and software such as dwell time on the web page, click sequence, scrolling range on the web page, internet protocol (IP) address, browser version and/or operating system (OS) can be randomly determined and combined to send request through the simulated user operation OP. In addition, when a request is sent, the abovementioned combination can be recorded, it can also be recorded if the data retrieval is successful with the simulated user operation OP corresponding to the combination, and a random request pool can be generated accordingly. The random request pool can be used to train the classification model for evaluating the probability of success of the simulated user operation OP.

For example, if the result web page 188 is successfully generated after performing the simulated user operation OP on the target web page 185, it can be determined that the result web page 188 complies with the predetermined rule, and the flow can enter Step 320.

In another condition, if the simulated user operation OP is identified as a crawler after performing the simulated user operation OP, and the result web page 188 is hence an invalid web page (e.g. it is redirected to the home page or a page of an unexpected language), it is determined that the result web page 188 is failed and does not comply to the predetermined rule in Step 310, and the flow can enter Step 330.

Regarding the settings of the browser in the simulated user operation OP, such as the browser add-on number, random parameters can be added by adding script, so as to modify the original settings of the webdrive. Regarding the modification of the webdrive, the modified items can include at least one of the trace of the headless web page, the default language of the browser, and the WebGLRenderingContext interface, etc.

Before sending the request of the simulated user operation OP, when a random combination of the features of the simulated user operation OP is generated, the classification model can be used to evaluate whether the data will be successfully retrieved. If the request is expected to fail and the data cannot be retrieved, the simulated user operation OP will not be performed to send the request, and a new random combination can be directly generated to generate a new simulated user operation OP. In this way, the time required to wait after the request of the simulated user operate OP fails can be reduced. The request of the newly generated simulated user operation OP will also be evaluated by the classification model. After the request is sent to the target web page 185, if the data can be successfully retrieved, or the data cannot be retrieved due to failure, the result can be recorded to update the random request pool and classification model in real time.

After retrieving the source code SC, when extracting the corresponding data, for the fields that will not change their tags for a long time, attribute tags can be used to define the location of the data. For example, “<div data-stid=”content-hotel-title“>hotel </h3>” can be used to directly locate data-stid as the data of “content-hotel-title”.

In addition, for the fields that will frequently change their tags, if the name of class is clearly not of a meaningful naming model, features can be obtained using relative locations under other fixed attributes with meaningful names. For example, if the tag of a hotel's corresponding name is “<div class=”sc-jSYIrd iMKnBy“>Hotel</div>”, and its upper layer is “<div id=“model”>Asiayo</div>”, the hotel name corresponding to the lower layer can be found using the attribute location of id—model.

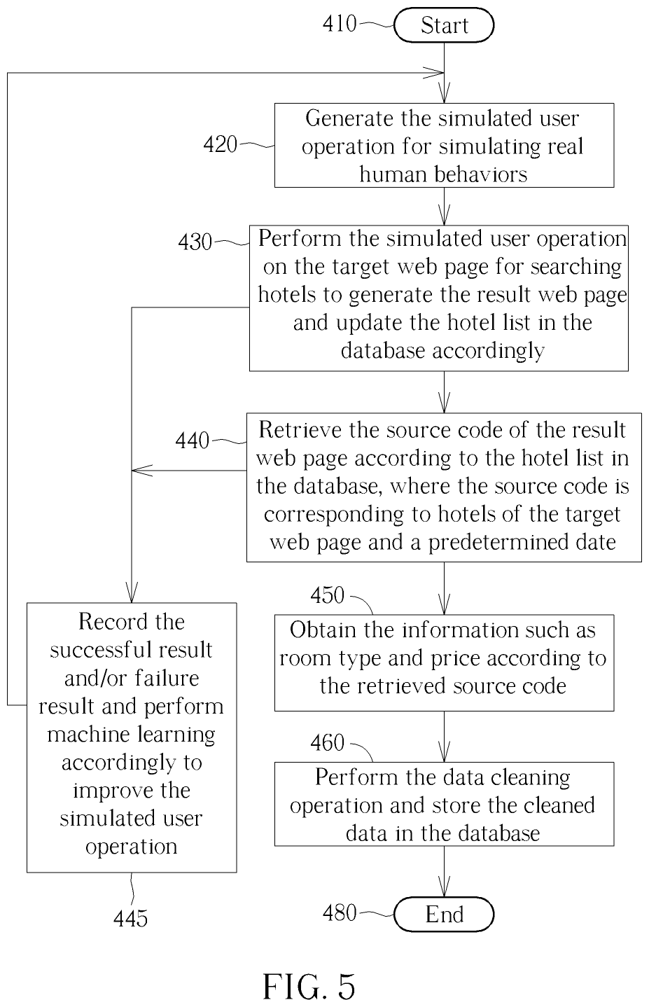

FIG. 5 illustrates a flowchart of obtaining the hotel information using the system 100 and steps mentioned in FIG. 1 to FIG. 4. As shown in FIG. 5, the following steps can be performed.

Step 410: start;

Step 420: generate the simulated user operation OP for simulating real human behaviors;

Step 430: perform the simulated user operation OP on the target web page 185 for searching hotels to generate the result web page 188 and update the hotel list in the database 130; perform Step 440 and Step 445;

Step 440: retrieve the source code SC of the result web page 188 according to the hotel list in the database 130, where the source code SC is corresponding to hotels of the target web page 185 and a predetermined date; perform Step 445 and Step 450;

Step 445: record the successful result and/or failure result in Step 430 and Step 440 and perform machine learning accordingly to improve the simulated user operation OP; perform Step 420;

Step 450: obtain the information such as room type and price according to the retrieved source code SC;

Step 460: perform the data cleaning operation and store the cleaned data D in the database 130; and Step 480: end.

In FIG. 5, Step 420 and Step 430 can be corresponding to Step 210 in FIG. 2. Step 440 can be corresponding to Step 220 in FIG. 2. Step 445 can be corresponding to Step 310, Step 320 and Step 330. Step 450 and Step 460 can be corresponding to Step 230 and Step 240.

As shown in FIG. 5, after performing the Step 430, in addition to Step 440, Step 445 can also be performed according to the result of Step 430 for adjusting and optimizing the simulated user operation OP. The adjusted and optimized simulated user operation OP can be used in the next data retrieval, that is, in the next execution of Step 420 and Step 430, so as to increase the probability of success of the subsequent data retrieval.

According to an embodiment, the source code of the target web page can be stored, and then features can be retrieved according to the source code because the data retrieval using crawler can be performed periodically (e.g. daily). If the features of fields are directly retrieved when crawling the web page, once the structure of the crawled website is changed, the code of the operation must be modified immediately, otherwise the data of the day cannot be retrieved. According to embodiments, the operation includes a source code crawling operation (related to Step 210 and Step 220 in FIG. 2) and a feature retrieving operation (related to Step 230 and Step 240 in FIG. 2). By storing the source code first (where it is allowed to not define the tags of the web page in this phase), even if the structure of the target web page is changed, and the retrieving program is not modified in real time, the corresponding data can still be retrieved since the source code has been stored.

According to an embodiment, machine learning can be used to predict the result of the request. The probability of success of each crawling request is not 100%. If the result of a request fails, the waiting time among multiple requests will increase the overall operation time. Further, on the target website, it may be difficult to reuse the internal protocol (IP) addresses used in previous failed requests. Hence, if machine learning can be used to predict the probability of success of the simulated user operation, the crawler will be less blocked, and the performance of the crawler will be improved.

In summary, by means of the system 100 and the method 200, the simulated user operation OP can be used for retrieving data on the target web page 185, and neural network and machine learning can be used to optimize the simulated user operation OP, so as to improve the effect of avoiding anti-crawler programs. Hence, the system 100 and the method 200 can improve the result of data retrieval.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for retrieving data on a web page, comprising:
performing a simulated user operation on a target web page to generate a result web page;
retrieving a source code of the result web page;
creating a data table according to the source code; and
performing a data cleaning operation with the data table to generate cleaned data and store the cleaned data in a database;
wherein each temporary row of the data table is corresponding to a quotation plan.

2. The method of claim 1, wherein:
the simulated user operation is performed on an operation date;
the simulated user operation comprises inputting at least one of a region name, a hotel name, a reservation date and number of people; and
the result web page and the cleaned data are corresponding to the operation date.

3. The method of claim 1, wherein:
the result web page is used to update a hotel list; and
the source code is retrieved according to the hotel list.

4. The method of claim 1, further comprising:
determining whether the result web page complies with a predetermined rule; and
if the result web page complies with the predetermined rule, outputting the simulated user operation and a successful result to a neural network module, so as to give a successful score to the simulated user operation for increasing a set of weights corresponding to the simulated user operation.

5. The method of claim 4, further comprising:
applying a classification model to evaluate a probability of success of a to-be-evaluated simulated user operation; and
if the probability of success is lower than a threshold, discarding the to-be-evaluated simulated user operation.

6. The method of claim 5, wherein the probability of success is the probability of using the to-be-evaluated simulated user operation to successfully retrieve related parameters of at least one of an internet-protocol address, a web-cache, a browser add-on number, a user agent and a hotel sequence.

7. The method of claim 1, further comprising:
determining whether the result web page complies with a predetermined rule; and
if the result web page fails to comply with the predetermined rule, outputting the simulated user operation and a failure result to a neural network module, so as to give a penalty score to the simulated user operation for decreasing a set of weights corresponding to the simulated user operation.

8. The method of claim 7, further comprising:
applying a classification model to evaluate a probability of success of a to-be-evaluated simulated user operation; and
if the probability of success is lower than a threshold, discarding the to-be-evaluated simulated user operation.

9. The method of claim 8, wherein the probability of success is the probability of using the to-be-evaluated simulated user operation to successfully retrieve related parameters of at least one of an internet-protocol address, a web-cache, a browser add-on number, a user agent and a hotel sequence.

10. The method of claim 1, wherein the simulated user operation comprises:
dwelling the target web page for x units of time;
scrolling the target web page upward by m units of length; and/or
scrolling the target web page downward by n units of length;
wherein x, m and n are integers, x≥0, m≥0, n≥0 and x, m and n are randomly determined.

11. The method of claim 1, wherein the source code comprises a HyperText Markup Language (HTML) source code.

12. A system for retrieving data on a web page, comprising:
an internet interface linked to a target web page at a remote terminal, and configured to perform a simulated user operation on the target web page to generate a result web page, and retrieve a source code of the result web page;
a processor linked to the internet interface, and configured to create a data table according to the source code, and perform a data cleaning operation with the data table to generate cleaned data; and
a database linked to the processor, and configured to store the cleaned data;
wherein each temporary row of the data table is corresponding to a quotation plan.
